(19) United States
(12) Patent Application Publication
(10) Pub. No.: US 2006/0281936 A1
(43) Pub. Date: Dec. 14, 2006

(54) Biofermented grain-based phytolipids and methods for isolating, modifying and using same

(76) Inventors: Ramaswamy Mani, Platte City, MO (US); Sukh D. Bassi, Atchison, KS (US); Clodualdo C. Maningat, Platte City, MO (US); Dharmen B. Makwana, Platte City, MO (US)

Correspondence Address: LATHROP & GAGE LC, 4845 PEARL EAST CIRCLE, SUITE 300, BOULDER, CO, 80301, US

(21) Appl. No.: 11/387,420

(22) Filed: Mar. 23, 2006

Related U.S. Application Data
(60) Provisional application No. 60/664,387, filed on Mar. 23, 2005.

(51) Int. Cl. C07F 9/02

(52) U.S. Cl. 554/8; 554/78

(57) ABSTRACT

Biofermented grain-based phytolipids are disclosed herein. In some embodiments, phytolipid-protein complexes, encapsulated phytolipids, and encapsulated phytolipid-protein complexes are disclosed. Methods for isolating, modifying and/or using biofermented grain-based phytolipids are also disclosed.

### RELATED APPLICATIONS

This application claims priority to U.S. application Ser. No. 60/664,387, filed Mar. 23, 2005, which is incorporated herein by reference.

### FIELD OF THE INVENTION

The present invention relates to biofermented grain-based phytolipids and methods of isolating, methods of modifying and methods of using the biofermented grain-based phytolipids.

### BACKGROUND

Lipids are aliphatic organic compounds that play important roles in living organisms. They generally have a nonpolar, hydrophobic tail or backbone portion and a polar, hydrophilic head group. This combination of polar and nonpolar properties enables lipids to form mechanically stable and chemically resistant barrier layers, e.g., cell walls.

Lipids also find many uses outside of living organisms, where, for example, they may be used in cosmetic, personal care and pharmaceutical applications. In these applications, lipids may form barriers that protect the skin or hair from environmental contaminants and trap moisture, or they may form micelles to encapsulate and transport agents of interest.

The lipids used in these applications are generally isolated from plant or animal sources. However, some lipid compounds are scarce or nonexistent in native plants, so that isolation of the compounds from animals is the only economic means of obtaining the desired compounds. Many consumers view the use of animals for these applications as undesirable and/or unethical, and they would prefer to buy and use products containing phytolipids (lipids derived from plants).

Phytolipids may, for example, include fatty acids, triglycerides, waxes, phospholipids, glycolipids, sphingolipids, sterols and isoprenoids. In particular, sphingolipids are among those lipids that are scarce in native plants.

Sphingolipids are a class of cell membrane lipids based on the sphingosine backbone: 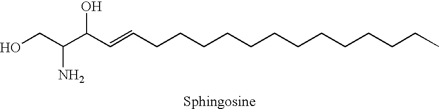
There are three main types of sphingolipids: ceramides, glycosphingolipids and phosphosphingolipids (a.k.a., sphingomyelins), which differ in the substituents on the sphingosine head group. For example, ceramides contain a fatty acid chain attached to the nitrogen atom of sphingosine. Glycosphingolipids are ceramides with one or more sugar residues bound at the 1-hydroxyl position. Phosphosphingolipids are ceramides having a phosphate group at the 1 -hydroxyl position.

Sphingolipids of plant origin, particularly glycosphingolipids, that have been isolated include those obtained from cereals and beans, such as rice (Agric. Biol. Chem., vol. 49, p. 2753 (1985)), rice bran (JP-A-62-187404 and JP-A-11-279586), wheat (Agric. Biol. Chem., vol. 49, p. 3609 (1985); U.S. Pat. Nos. 5,466,782 and 6,576,266), and soybeans (Chem. Pharm. Bull., vol. 38, No. 11, p. 2933 (1990)). However, native cereals and beans typically have limited glycosphingolipid concentrations of around 0.01% by weight.

Biofermentation

Biofermentation, the fermentation of biomass, e.g., grains, to produce ethanol is a well known process. The ethanol produced by biofermentation may be consumed in the form of spirits, utilized as an industrial solvent, or provided as an alternative fuel.

Grains are prepared for fermentation by milling into a fine powder or meal. This process cracks the hard outer shell and exposes the starch portion of the grain. Next, the grain is mixed with water to create a mash, which is heated to liquefy the starch. The mash is cooled and enzymes are added; the enzymes degrade the starch into simple sugars. Yeast is added to the mash to affect fermentation, which converts the sugars into ethanol. The ethanol is distilled from the fermented mash and the remaining solids and liquids are dried and sold as distillers dried grains with solubles (DDGS). Distillers dried grains with solubles are usually used as livestock feed.

### SUMMARY

The present instrumentalities advance the art and overcome the problems that are outlined above.

In one aspect, a method for isolating phytolipids from biofermented grain includes adding biofermented grain to a solvent to create an extraction mixture; heating the extraction mixture; filtering the extraction mixture; and removing the solvent from the filtrate to obtain the isolated phytolipids.

In another aspect, a cosmetic composition includes isolated phytolipids in a weight proportion ranging from 0.01 to 10%.

In one aspect, a phytolipid-protein complex includes a hydrolyzed protein selected from the group consisting of hydrolyzed wheat protein, hydrolyzed soy protein, hydrolyzed rice protein, hydrolyzed oat protein and mixtures thereof, and a phytolipid.

In one aspect, an encapsulated phytolipid includes a phytolipid and an encapsulating agent, wherein the encapsulating agent is selected from the group consisting of starch, maltodextrin and combinations thereof.

### DETAILED DESCRIPTION

Methods for isolating compositions containing phytolipids from biofermented grains, such as corn, sorghum, wheat, barley, rye, oats, and rice are described herein. In one embodiment, distillers dried grains with solubles (DDGS), such as corn and/or sorghum DDGS, may be used as the biofermented grain(s).

The phytolipids extracted from biofermented grains have compositions which may otherwise be unobtainable from pure unfermented grain. For example, the phytolipids derived from biofermented grain contain glycolipids, phospholipids and sphingolipids, whereas phytolipids derived from unfermented grain contain scarce or nonexistent quantities of sphingolipids. For comparison, biofermented grain contains approximately 3-6% by weight sphingolipids.

Phytolipids may be isolated from biofermented grain by solvent extraction and/or supercritical fluid extraction. For example, batch extractors, counter-current extractors and supercritical fluid extractors may be used with solvents selected from the group consisting of water; alcohols, such as ethanol; fluorocarbons, such as iodotrifluoromethane; carbon dioxide and mixtures thereof.

The term “isolated” as used herein refers to a composition that has been separated from its natural milieu, and does not reflect the extent to which the composition has been purified.

Isolated phytolipids may be obtained as extracts, oils or powders. At room temperature, isolated phytolipids are generally in the form of oils; however, solutions containing phytolipids may also be freeze dried or spray dried to produce the isolated phytolipids as solid powders. Extracts are concentrates containing a mixture of phytolipid oil and one or more solvents, such as an alcohol.

The extracted phytolipids can be further fractionated to obtain a polar rich fraction having an enhanced sphingolipid concentration. In particular, ceramides, glycosphingolipids and phospholipids (including phosphosphingolipids and phosphate-containing molecules with structures related to triglycerides) are present in the polar rich fraction.

In one embodiment, phytolipids may be combined with proteins to form phytolipid-protein complexes. For example, phytolipids may form micelles that encapsulate proteins; thus rendering the encapsulated proteins water-soluble.

In another embodiment, phytolipids or phytolipid-protein complexes may be encapsulated. Exemplary encapsulating agents include starch and/or maltodextrin. For example, encapsulation of phytolipids or phytolipid-protein complexes with starch and/or maltodextrin may prevent clumping and improve glide.

Isolated phytolipids, phytolipid-protein complexes, encapsulated phytolipids and/or encapsulated phytolipid-protein complexes may be used in cosmetic, personal care and pharmaceutical applications.

The following examples teach by way of illustration, and not by limitation, to illustrate preferred embodiments of what is claimed.

### EXAMPLE 1

### Extraction Procedures

A. Batch Extraction

Batch extraction was carried out using 95-100% ethanol. Biofermented grains were introduced into ethanol with vigorous stirring at various feed to solvent ratios (1:1 to 1:10). In a typical extraction, a 1:5 ratio of feed to ethanol was used. The extraction mixture was continuously agitated for 1-2 hours at temperatures ranging from ambient to 80° C., typically 50° C. The mixture was then filtered using a bag filter and concentrated by distillation to obtain an oil. The concentrated oil had a composition of triglycerides (40-50%), free fatty acids (15-20%), phytosterols (5-10%), ceramides (3-6%), phospholipids (4-8%) and vitamin E (0.2-1%), as determined by high-performance liquid chromatography (HPLC).

B. Counter-Current Extraction

Biofermented grains were introduced into either an immersion-type or a percolation-type counter-current extractor. Ethanol (95-100%) was used as the extraction solvent, with a feed to solvent ratio between 1:1 and 1:5. The temperature of the mixture was maintained at 30-70° C. for 0.5 to 1 hour. The miscella, a mixture of solvent and oil, was concentrated by distillation to obtain the oil. The concentrated oil had a composition of triglycerides (40-50%), free fatty acids (15-20%), phytosterols (5-10%), ceramides (3-6%), phospholipids (4-8%) and vitamin E (0.2-1%), as determined by HPLC.

C. Extraction of Polar Rich Lipids

Two stage counter-current extractions were performed to extract polar rich lipids from biofermented grains. The biofermented grains were first subjected to nonpolar solvents, such as hexanes, to remove nonpolar fractions. In the second stage, the nonpolar fraction was removed. Grains were then subjected to a polar solvent, such as 95-100% ethanol, to extract polar rich lipids. The miscella of the polar rich fraction was then concentrated by distillation to obtain an oil including ceramides, phospholipids and glycosphingolipids.

D. Continuous Fluorocarbon Extraction

Fluorocarbons, such as iodotrifluoromethane, were used to extract lipids from biofermented grains. The biofermented grains were extracted using various combinations of material input (50-100%), extraction temperature (25-85° C), flow rate (60-90%) as a function of pump rate, and time (1-5 hours). The resulting oil had a composition of triglycerides (22-62%), free fatty acids (3-15%), phytosterols (4-9%), ceramides (2-4%) and vitamin E (0.1-0.4%), as determined by HPLC.

In one embodiment, polar rich lipids may be extracted using fluorocarbons with polar co-solvents, such as ethanol.

E. Supercritical Fluid Extraction

Biofermented grains were extracted with various combinations of C0₂ pressure (100 to 600 bar), flow rate (0 to 200 g/min), extraction temperature (40 to 150° C.), and time (2-4 hours). The resulting oil had a composition of triglycerides (40-60%), free fatty acids (10-20%), phytosterols (5-8%), ceramides (2-3%) and vitamin E (0.2-0.4%), as determined by HPLC.

When ethanol (up to 20%) was used as a modifier, the resulting oil had a higher concentration of polar lipids, particularly ceramides, phospholipids and glycosphingolipids.

### EXAMPLE 2

### Phytolipid-Protein Complexes

Extracted phytolipids (whole fraction or polar rich fraction) may be combined with proteins to form phytolipid-protein complexes.

The powdered form of a phytolipid-protein complex was produced as described below:
A. Biofermented grains were extracted using 1-99% by weight of ethanol in either a batch or counter-current extractor at a temperature between 30-70° C. The extract was concentrated through distillation to remove all ethanol and then freeze dried or spray dried.
B. Phytolipid powder, prepared as described above, was mixed with various hydrolyzed proteins (e.g., wheat, soy, rice, oat). The phytolipid to protein ratio was between 1:5 to 1:50, typically 1:15. The mixture was mixed at room temperature for 30 minutes and then either freeze dried or spray dried to obtain the powdered form of the phytolipid-protein complex.

### EXAMPLE 3

### Encapsulation of Phytolipids or Phytolipid-Protein Complexes

Extracted phytolipids (whole fraction or polar rich fraction) may be encapsulated, either alone or in the form of phytolipid-protein complexes, using maltodextrin and/or starch (modified or unmodified). The encapsulated products may be used as multi-component controlled delivery systems for dry powder compositions in cosmetics, personal care and pharmaceutical applications, as discussed below.

### EXAMPLE 4

### Cosmetic and Personal Care Formulations

Cosmetic formulations such as shampoos, shampoo conditioners, hair styling gels, hair conditioners, hair reparatives, bath and shower gels, skin lotions and creams, shaving creams and sunscreens, as well as dry powder formulations such as baby powders, body talcs, deodorizing powders, foot powders and anti-fungal powders can be improved by incorporation of a phytolipid extract therein.

The following products were produced using the phytolipid extracts described herein.

(i) Moisturizing Sunscreen Lotion

| Phase | Trade Name (INCI Name) | Amount | Producer |
|---|---|---|---|
| A | Aqua | QS | QS |
| A | Versene NA (Disodium EDTA) | 0.10 | Doe Chemical |
| A | Acritamer 940 (Carbomer) | 0.15 | Rita |
| A | AMP 95 Regular | QS | Angus |
| | (2-Amino-2-Methyl-1-Propanol) | | |
| B | Stepan DGS SE | 2.00 | Stepan |
| B | Ceteryl Alcohol Ceteareth-20 | 1.50 | Amerchol |
| B | Liponate SPS (Cetyl Ester) | 1.50 | Lipo |
| B | Lipovol MS-70 (Mineral Oil) | 0.50 | Lipo |
| B | Glyceryl Sterate & PEG 100 Sterate | 2.50 | Lipo |
| B | Dow Corning 200-350 ct | 0.50 | Dow Corning |
| | (Dimethicone) | | |
| B | Ethylhexyl Methoxycinnamate | 7.00 | Jeen |
| B | C12-15 Alkyl Benzoate | 2.75 | Fintex |
| C | Phytolipid Extract | 0.50 | MGP Ingredients |
| D | Preservative | QS | QS |
| D | Fragrance | 0.05 | Belmay |

In a suitable primary tank, the required amount of distilled water was metered out. Part A ingredients were added to the tank and the mixture was heated to 75° C. In a secondary tank, the Part B ingredients were weighed out in order and heated to 75° C. Part B was added to Part A and cooling was started. Part C was added to the batch when the temperature reached 60° C. Part D was added to the batch when the temperature reached 40° C.

(ii) Shampoo for Damaged Hair

| Phase | Trade Name (INCI Name) | Amount | Producer |
|---|---|---|---|
| A | Distilled Water | Adjust | QS |
| A | Acrylate/C10-30 Alkyl | 0.20 | BF Goodrich |
| A | PK-771 (PVP) | 2.80 | Henkle |
| A | Polyquaternium-7 | 0.10 | Calgon |
| A | Versene NA2 (Disodium EDTA) | 0.10 | Dow Chemical |
| A | PEG-7 Glycerox HE | 0.20 | Jeen |
| A | Stepanol CS-230 | 25.00 | Stepan |
| | (Sodium Laureth Sulfate) | | |
| A | Stepanol WAC (Sodium Lauryl Sulfate) | 10.00 | Stepan |
| A | Mackham 35 (Cocomidopropyl Betaine) | 2.50 | Mclntyre |
| A | Jojoba Oil Yellow | 0.50 | Desert Whales |
| | | | Inc |
| A | Almond Oil | 0.10 | Spectrum |
| A | Phytolipid Extract | 1.00 | MGP |
| | | | Ingredients |
| A | Glycerin USP | 2.00 | Spectrum |
| B | D-L Panthenol (Panthenol) | 0.05 | Rhoch |
| B | Aloe Vera Extract | 0.03 | Active Organic |
| B | Rosehip Extract | 0.06 | Active Organic |
| C | Preservative (Propylene Glycol and | QS | QS |
| | Diazolidinyl Urea and Methylparaben | | |
| | and Propylparaben) | | |
| C | Fragrance | 0.10 | Belmay |
| C | FD&C Blue # 01 | QS | BASF |

In a suitable primary tank, the required amount of distilled water was metered out. Part A ingredients were added to the tank in the order listed. Part B ingredients were added to the tank. Part C ingredients were added to the tank in the order listed. The pH was adjusted to 5.5-6.5 (25% AMP 95) and the viscosity was adjusted with NaCI to the desired thickness.

(iii) Moisturizing Hand Cream

| Phase | Trade Name | Amount |
|---|---|---|
| A | Distilled Water | QS |
| A | Glycerin (VW&R) | 1.50 |
| B | Triple Press Stearic Acid | 3.00 |
| B | Glyceryl Monosterate | 2.00 |
| B | Cetyl Alcohol | 2.00 |
| B | Cetearyl Alcohol and Ceteareth-20 | 1.00 |
| B | Steraryl Alcohol | 1.00 |
| B | Coconut Oil | 0.50 |
| B | Isopropyl Myristate | 0.50 |
| B | Isopropyl Palmitate | 0.50 |
| B | Jojoba Oil | 0.75 |
| B | Methylparaben | 0.20 |
| B | Propylparaben | 0.15 |
| B | Phytolipid Extract | 1.50 |
| C | Dimethicone 200 Fluid | 0.50 |
| C | Phenoxyethanol | 0.30 |
| D | Fragrance | QS |

In a suitable primary tank, the required amount of distilled water was metered out. Part A ingredients were added to the tank and the mixture was heated to 75° C. In a secondary tank, the Part B ingredients were heated to 75° C. Part B was added to Part A and cooling was started. Part C was added to the batch with rapid mixing when the temperature reached 65° C. Part D was added to the batch when the temperature reached 35° C.

(iv) Moisturizing Liquid Make-Up

| Phase | Trade Name (INCI Name) | Amount |
|---|---|---|
| A | Deionized Water | Adjust |
| | Triethanolamine 99% (universal) | QS |
| | Propylene Glycol (universal) | 5.00 |
| | Carbomer-940 (Carbomer) | 0.20 |
| | Veegum | 0.30 |
| B | Stearic Acid (lipo) | 1.00 |
| | PEG-120 Dimethyl Glucose Sesquesterate | 1.00 |
| | Sterate-20 | 0.80 |
| | Cetyl Alcohol | 0.50 |
| | Ceteth-20 | 0.50 |
| | Methyl Glucose Sesquesterate | 1.00 |
| | Nylon-12 (Lipo) | 3.50 |
| | Phytolipid Extract | 0.50 |
| C | Isopar-G | 0.20 |
| | Isopar-M | 0.20 |
| D | Silica Dimethyl Siliylate (Cabot) | 1.00 |
| | Cyclomethicone (Dow Corning) | 15.00 |
| E | Titanium Dioxide (Rona) | 2.00 |
| | Iron Oxide Yellow (BFGoodrich) | 0.40 |
| | Iron Oxide Black (BFGoodrich) | 0.20 |
| | Iron Oxide Red (BFGoodrich) | 0.30 |
| F | Polysorbate-20 | 1.00 |
| G | Preservative | QS |
| H | Fragrance | QS |

In a suitable primary tank, the required amount of deionized water was metered out. Part A ingredients were added to the tank and the mixture was heated to 75° C. Part E ingredients were pressed through a colloid mill with some propylene glycol and recirculated until the pigments were evenly dispersed. The colloid mill was rinsed with Part C and a lightning mixer was used to thoroughly mix the ingredients, which were heated to 75° C. In a secondary tank, the Part B ingredients were premixed and heated to 75° C. Part B was added to the main batch. Part E was added to the main batch. Part D was premixed and then added to the main batch when the temperature reached 65° C. Part F was added to the main batch when the temperature reached 40° C. The preservative and fragrance were added. The pH and viscosity were adjusted to desired levels.

(v) Moisturizing Lipstick

| Phase | Trade Name | Amount |
|---|---|---|
| Part-A | Castor Oil | Adjust |
| | Candelilla Wax | 4.50 |
| | Carbauna Wax | 1.50 |
| | Ozokerite | 1.25 |
| | Microcrystalline Wax | 2.50 |
| Part-B | Caprylic Capric Triglyceride | 12.00 |
| | Mineral Oil | 1.50 |
| | Octyldodecyl Stearyl Sterate | 4.00 |
| | Isopropyl Myristate | 1.00 |
| | Isopropyl Palmitate | 1.00 |
| | Vitamin-E | 0.05 |
| Part-C | Iron Oxide Yellow (BFGoodrich) | QS |
| | Iron Oxide Black (BFGoodrich) | QS |
| | Iron Oxide Red (BFGoodrich) | QS |
| Part-D | Castor Oil | 5.00 |
| | Phytolipid Extract | 1.50 |
| Part-E | Preservative | QS |
| | Fragrance | QS |

Part A ingredients were added to a tank and heated to 75° C. In a secondary tank, the Part B ingredients were heated to 75° C. Part B was added to Part A. Part C and Part D were premixed and then added to the A-B mixture. The temperature was maintained at 75° C. until the color was uniform. The preservative and fragrance were added. The mixture was then set in molds at 45° C.

(vi) Moisturizing Liquid Talc (Lotion)

| Phase | Trade Name | Amount | Producer |
|---|---|---|---|
| A | Distilled Water | Adjust | QS |
| A | Glycerin USP | 1.00 | VW&R |
| B | Cetyl Alcohol | 1.50 | Lipo |
| B | Steric Acid | 1.50 | Lipo |
| B | Stearyl Alcohol | 0.50 | Stepan |
| B | Cetryl Alcohol & Ceteraeth-20 | 0.80 | Amerchol |
| B | GMS 450 (Glyceryl Sterate) | 0.50 | Rita |
| B | Isopropyl Palmitate | 1.00 | Stepan |
| B | Dow Corning - 200 350 Ct | 0.20 | Dow Corning |
| | (Dimethicone) | | |
| B | Isopropyl Myristate | 2.00 | Lipo |
| C | SD-40 (Alcohol) | 20.00 | MGP Ingredients |
| C | Phytolipid Extract | 0.50 | MGP Ingredients |
| C | Fragrance | 0.20 | Belmay |
| C | Preservative | QS | QS |

Part A ingredients were added to a tank and heated to 75° C. In a secondary tank, the Part B ingredients were heated to 75° C. Part B was added to Part A. The batch was cooled to 35° C. and the Part C ingredients were added in the order listed.

(vii) Facial Mask

| Phase | Trade Name | Amount |
|---|---|---|
| A | Deionized Water | Adjust |
| A | Carbomer 940 (Carbomer) | 0.15 |
| A | TEA (99%) (Triethanolamine) | QS |
| B | China Clay (Clay) | 12.00 |
| B | Eusolex T-200 (Titanium Dioxide) | 0.50 |
| C | Propylene Glycol | 5.00 |
| C | L-Menthol | 0.10 |
| D | Preservative | QS |
| D | Aqua Pro ™ II WP | 1.50 |
| | (Hydrolyzed Wheat Protein) | |
| D | Aqua Pro ™ II WAA | 0.50 |
| | (Wheat Amino Acid) | |
| D | Phytolipid Extract | 1.00 |
| D | Fennel Extract | 0.50 |

Part A ingredients were added to a tank and mixed until a uniform solution resulted. The solution was then heated to 75° C. and cooling was started. When the temperature reached 45° C., the Part B ingredients were sprinkled into Part A in the order listed. Part C was premixed and then added to the batch. The ingredients of Part D were added in the order listed.

(viii) Moisturizing Soap Bar

| Phase | Trade Name | Amount (g) |
|---|---|---|
| A | Almond Oil | 2.00 |
| A | Canola Oil | 10.00 |
| A | Coconut Oil | 20.00 |
| A | Jojoba Oil | 3.00 |
| A | Mango Oil | 3.00 |
| A | Palm Kernel Oil | 10.00 |
| A | Safflower Oil | 12.00 |
| A | Soybean Oil | 7.00 |
| A | Sunflower Oil | 4.00 |
| A | Phytolipid Extract | 0.50 |
| B | Sodium Hydroxide | 20.00 |
| B | Aqua | 19.00 |
| C | Fragrance | 3.00 |
| C | Color | QS |

In a suitable primary tank, the Part A ingredients were mixed and heated to 45° C. In a secondary tank, the Part B ingredients were premixed and then combined with Part A. The mixture was stirred until tracing was observed (˜20-25 minutes). Part D was added to the batch and stirred. The soap was poured into molds and then covered with a warm blanket for 24 hours. The soap was removed from the molds and allowed to cure for a few days.

Changes may be made in the above compositions and methods without departing from the subject matter described in the Summary and defined by the following claims. It should thus be noted that the matter contained in the above description should be interpreted as illustrative and not limiting.

All references cited are incorporated by reference herein.

We claim:

1. A method for isolating phytolipids from biofermented grain comprising:
adding biofermented grain to a solvent to create an extraction mixture;
heating the extraction mixture;
filtering the extraction mixture; and
removing the solvent from the filtrate to obtain the isolated phytolipids.

2. The method of claim 1, wherein the solvent comprises an alcohol.

3. The method of claim 2, wherein the alcohol is ethanol.

4. The method of claim 1, wherein the solvent comprises a fluorocarbon.

5. The method of claim 4, wherein the fluorocarbon is iodotrifluoromethane.

6. The method of claim 1, wherein the solvent comprises a supercritical fluid.

7. The method of claim 6, wherein the supercritical fluid is carbon dioxide.

8. The method of claim 1, further comprising a first step of extracting non-polar fractions from the biofermented grain.

9. The method of claim 1, wherein the isolated phytolipids are in the form of an extract.

10. The method of claim 1, wherein the isolated phytolipids are in the form of an oil.

11. The method of claim 1, wherein the isolated phytolipids are in the form of a powder.

12. The method of claim 1, wherein the biofermented grain is selected from corn, sorghum, wheat, barley, rye, oats, rice and combinations thereof.

13. The method of claim 1, wherein the biofermented grain is selected from corn distillers dried grains with solubles, sorghum distillers dried grains with solubles and combinations thereof.

14. The method of claim 1, further comprising encapsulating the isolated phytolipids in an encapsulating agent, wherein the encapsulating agent is selected from the group consisting of starch and maltodextrin.

15. The method of claim 1 further comprising mixing the isolated phytolipids with protein to form a phytolipid-protein complex.

16. The method of claim 15, further comprising encapsulating the phytolipid-protein complex in an encapsulating agent, wherein the encapsulating agent is selected from the group consisting of starch and maltodextrin.

17. A cosmetic composition comprising the isolated phytolipids of claim 1 in a weight proportion ranging from 0.01 to 10%.

18. A phytolipid-protein complex comprising:
a hydrolyzed protein selected from the group consisting of hydrolyzed wheat protein, hydrolyzed soy protein, hydrolyzed rice protein, hydrolyzed oat protein and mixtures thereof; and
a phytolipid.

19. The phytolipid-protein complex of claim 18 further comprising an encapsulating agent selected from the group consisting of starch, maltodextrin and combinations thereof.

20. An encapsulated phytolipid comprising a phytolipid and an encapsulating agent, wherein the encapsulating agent is selected from the group consisting of starch, maltodextrin and combinations thereof.
